(19) United States
(12) Patent Application Publication
(10) Pub. No.: US 2021/0092219 A1
(43) Pub. Date: Mar. 25, 2021

(54) APPARATUS AND CONTROL METHOD FOR RECOMMENDING DO-NOT-DISTURB MODE BASED ON CONTEXT-AWARENESS

(71) Applicant: LG ELECTRONICS INC., Seoul (KR)

(72) Inventors: Jeong Hwan Hwang, Seoul (KR); Dae San Kang, Seoul (KR); Byeong Soo Kim, Seoul (KR); Ji Yeon Kim, Seoul (KR); Hee Jin Kim, Seoul (KR); Yoon Ok Nam, Seoul (KR); Ji Young Lee, Seoul (KR); Ji Na Choi, Seoul (KR)

(73) Assignee: LG ELECTRONICS INC., Seoul (KR)

(21) Appl. No.: 16/669,415

(22) Filed: Oct. 30, 2019

(30) Foreign Application Priority Data
Sep. 23, 2019 (KR) 10-2019-0116658

(51) Int. Cl. H04M 1/725

(52) U.S. Cl. CPC H04M 1/72577; H04M 2250/12; H04M 2203/6054

(57) ABSTRACT

Presented are an apparatus and a control method, which execute an artificial intelligence (AI) algorithm and/or a machine learning algorithm and recommend a do-not-disturb mode based on a context recognized by an electronic equipment user in a 5G environment connected for the Internet of Things (IoT). An apparatus control method includes collecting user context information including time information and place information from at least one of data stored in a sensor, a communication module, or a memory of an electronic equipment, determining the recommendation of a do-not-disturb mode by applying the user context information to a learning engine, and displaying, on a display, a user interface capable of setting the do-not-disturb mode based on the determination of the recommendation of the do-not-disturb mode.

### CROSS-REFERENCE TO RELATED APPLICATION

Pursuant to 35 U.S.C. § 119(a), this application claims the benefit of earlier filing date and right of priority to Korean Patent Application No. 10-2019-0116658, filed on Sep. 23, 2019, the contents of which are hereby incorporated by reference herein in its entirety.

### BACKGROUND

### 1. Technical Field

The present disclosure relates to an apparatus and a control method for recommending a do-not-disturb mode of electronic equipment, and more particularly, to an apparatus and a control method for recommending a do-not-disturb mode based on a context recognized by an equipment user.

### 2. Description of Related Art

Recently, the types of electronic equipment held by individuals, such as a smartphone, are diversified, and the functions of the electronic equipment are also increasing.

Further, in light of the tendency to focus on individual time and the context where the need for efficient time management increases, users feel the need to control the notification (sound, screen brightness, vibration, or the like) of the electronic equipment in a specific context.

In other words, a do-not-disturb mode of the electronic equipment is required in the context where the user needs to concentrate, but there is a problem in that the usage rate of the do-not-disturb mode is low because of the complicated setting method of the do-not-disturb mode setting of a conventional electronic equipment and the hassle that the user should set the do-not-disturb mode one-by-one according to the context.

Further, since the conventional do-not-disturb mode only provides a method of releasing a time-based do-not-disturb mode that is released after a setting time, there is a problem in that it is difficult to set the release time of the do-not-disturb mode if the hold time required for the do-not-disturb mode is not determined.

The related art 1 discloses a technology of providing an interface for setting a do-not-disturb mode on an interface for a user to input a schedule, and of providing an interface for selecting a notification not to be received in the do-not-disturb mode.

The related art 1 has the advantage capable of setting the do-not-disturb mode according to the input schedule of the user, but there is a problem in that the related art 1 is not based on the user's context, is only the degree in which the user simply sets the do-not-disturb mode according to the schedule, and does not disclose the method of releasing the do-not-disturb mode.

The related art 2 discloses a technology of setting and releasing a do-not-disturb mode that is automatically activated by a device.

The related art 2 has the advantage of eliminating the user's hassle by automatically setting and releasing the do-not-disturb mode according to the facing orientation of a device display, but there is a problem in that the related art 2 drives the do-not-disturb mode simply based on the facing orientation of the display rather than the user's context, thereby frequently setting and releasing the do-not-disturb mode and setting the do-not-disturb mode at the point of time not required by the user.

### RELATED ART DOCUMENTS

### Patent Documents

Related Art 1: Korean Patent Laid-Open Publication No. 10-2014-0028426 (published on Mar. 10, 2014)

Related Art 2: Korean Patent Laid-Open Publication No. 10-2016-0083947 (published on Jul. 12, 2016)

### SUMMARY OF THE DISCLOSURE

An aspect of the present disclosure is to provide a method and an electronic equipment for recommending a do-not-disturb mode based on a user's context who uses an electronic equipment.

Another aspect of the present disclosure is directed to providing a method and an electronic equipment for recommending a do-not-disturb mode to a user based on time information and place information where the user is positioned in order to provide convenience to the user at the time of setting a do-not-disturb mode.

Still another aspect of the present disclosure is directed to providing a method and an electronic equipment capable of releasing a do-not-disturb mode based on a place in order to provide convenience of releasing and setting a do-not-disturb mode if the time required for holding the do-not-disturb mode of the user is not determined.

Yet another aspect of the present disclosure is directed to providing a method and an electronic equipment capable of releasing a do-not-disturb mode based on biometric information and motion information of a user in order to provide convenience of setting and releasing the do-not-disturb mode based on the user's context.

An apparatus control method of an electronic equipment according to an embodiment of the present disclosure controls an electronic equipment so as to recommend a do-not-disturb mode setting to a user based on a result of applying time information and context information to a learning engine.

Specifically, an apparatus control method of an electronic equipment according to an embodiment of the present disclosure may include collecting user context information including time information and place information from at least one of data stored in a sensor, a communication module, or a memory of an electronic equipment, determining the recommendation of a do-not-disturb mode by applying the user context information to a learning engine, and displaying, on a display, a user interface capable of setting the do-not-disturb mode based on the determination of the recommendation of the do-not-disturb mode.

Through the apparatus control method according to the present embodiment, it is possible for the electronic equipment to recommend the setting of the do-not-disturb mode based on the user's context, thereby improving the user's convenience of using the electronic equipment.

Further, the apparatus control method may further include, before the collecting the user context information, determining whether the electronic equipment is positioned at the same place for a predetermined reference time, generating learning information including the time information and the place information, based on a result of determining that it is positioned at the same place, determining repeatability of the learning information, generating pattern information based on the determination result of the repeatability of the learning information, and setting the pattern information as a determination reference of the learning engine.

Through the apparatus control method according to the present embodiment, it is possible for the electronic equipment to set the determination reference of the learning engine capable of recommending the do-not-disturb mode setting.

Further, the collecting the user context information may further include receiving biometric information from a device connected with the electronic equipment, and the determining the recommendation of the do-not-disturb mode may further include applying the user context information including the biometric information to the learning engine.

Further, the collecting the user context information may further include collecting motion information related to the user's movement from a device connected with the electronic equipment or the sensor, and the determining the recommendation of the do-not-disturb mode may further include applying the user context information including the motion information to the learning engine.

Through the apparatus control method according to the present embodiment, it is possible for the electronic equipment to recommend the setting of the do-not-disturb mode by accurately determining the user's context.

Further, the apparatus control method may further include, after the displaying the user interface on the display, receiving an input for setting the do-not-disturb mode from a user and displaying the user interface for setting the do-not-disturb mode release condition on the display.

Through the apparatus control method according to the present embodiment, it is possible for the electronic equipment to recommend the setting of the do-not-disturb mode by accurately determining the user's context.

Further, the do-not-disturb mode release condition may include the do-not-disturb mode release condition based on a place, and the apparatus control method may further include, after the displaying the user interface for setting the do-not-disturb mode release condition, monitoring received radio wave, determining the satisfaction of the do-not-disturb mode release condition based on the place based on the radio wave, and releasing the do-not-disturb mode based on the satisfaction determination result of the do-not-disturb mode release condition based on the place.

Through the apparatus control method according to the present embodiment, it is possible to improve the convenience of the do-not-disturb mode release setting if the time required for holding the do-not-disturb mode of the user is not determined.

Further, the collecting the user context information may include collecting the user context information by extracting the time information and the place information from message data or schedule data stored in a memory.

Through the apparatus control method according to the present embodiment, it is possible to improve the convenience of the do-not-disturb mode release setting for the user's schedule.

Further, the apparatus control method may further include, before the collecting the user context information, receiving, from a server device, the learning engine based on machine learning trained in advance so as to determine whether it is a context where the do-not-disturb mode is required based on the time information and the place information.

Further, the apparatus control method may further include, after the displaying the user interface on the display, monitoring whether the do-not-disturb mode of the user has been set and retraining the learning engine based on the monitoring result.

Through the apparatus control method according to the present embodiment, it is possible to improve the accuracy of the learning engine that recommends the setting of the do-not-disturb mode.

Further, the apparatus control method may further include, after the retraining the learning engine, transmitting information related to a difference between the received learning model and the retrained learning model to the server device.

Through the apparatus control method according to the present embodiment, it is possible for the server device to improve the learning model held by the server device by using the difference between the learning models received from the electronic equipment.

Further, the apparatus control method may further include, after the displaying the user interface on the display, receiving an input for setting the do-not-disturb mode from a user, monitoring received radio wave, determining whether to leave the place related to the place information based on the radio wave, and releasing the do-not-disturb mode based on the leave determination result of the place related to the place information.

Through the apparatus control method according to the present embodiment, it is possible for the electronic equipment to release the do-not-disturb mode based on the place even without the setting of the do-not-disturb mode release condition, thereby improving the convenience of the setting of the do-not-disturb mode of the user.

An apparatus control method of an electronic equipment according to an embodiment of the present disclosure may include extracting time information and place information from at least one of data stored in a sensor, a communication module, or a memory of an electronic equipment, and collecting first user context information by receiving biometric information from a device connected to the electronic equipment, determining the application of a do-not-disturb mode by applying the first user context information to a learning engine, and setting, by the electronic equipment, the do-not-disturb mode, based on the application determination of the do-not-disturb mode.

Through the apparatus control method according to the present embodiment, it is possible for the electronic equipment to set the do-not-disturb mode by accurately determining the user's context, thereby improving the convenience of using the do-not-disturb mode of the user.

Further, the collecting the first user context information may further include collecting motion information related to the user's movement or biometric information from the connected device or the sensor mounted on the electronic equipment, and the determining the application of the do-not-disturb mode may further include applying the first user context information including the motion information or the biometric information to the learning engine.

Through the apparatus control method according to the present embodiment, it is possible to improve the accuracy of the learning engine that sets the do-not-disturb mode.

Further, the apparatus control method may include, after the setting the do-not-disturb mode, receiving the biometric information from the connected device and collecting second user context information by collecting the motion information related to the user's movement from the connected device or the sensor mounted on the electronic equipment, determining the release of the do-not-disturb mode by applying the second user context information to the learning engine, and releasing, by the electronic equipment, the do-not-disturb mode based on the release determination of the do-not-disturb mode.

Through the apparatus control method according to the present embodiment, it is possible for the electronic equipment to release the do-not-disturb mode by accurately determining the user's context, thereby improving the convenience of using the do-not-disturb mode of the user.

A computer readable recording medium according to still another embodiment of the present disclosure may be a computer readable recording medium in which at least one program configured to execute the above-described apparatus control method when executed by an electronic equipment is recorded.

An electronic equipment according to a yet another embodiment of the present disclosure may include a processor, a memory electrically connected with the processor, and configured to store at least one instruction and a parameter of a learning model, which are performed in the processor, at least one sensor configured to sense physical information, a communication module, and a display configured to display a user interface. The processor may be configured to generate user context information including time information and place information from at least one of data stored in the sensor, the communication module, or the memory, to determine the recommendation of a do-not-disturb mode by applying the user context information to a learning engine, and to display, on the display, the user interface capable of setting the do-not-disturb mode based on the determination of the recommendation of the do-not-disturb mode.

Further, the processor may be configured to generate learning information including the time information and the place information based on the result of determining whether the electronic equipment is positioned at the same place for a predetermined reference time, and to set pattern information generated based on the repeatability determination result of the learning information as a determination reference of the learning engine.

Further, the processor may be configured to generate the user context information by further including biometric information received through the communication module from a device connected with the electronic equipment, and to determine the recommendation of a do-not-disturb mode by applying the user context information including the biometric information to the learning engine.

Further, the processor may be configured to generate the user context information by including motion information related to the user's movement received from the device connected with the electronic equipment or collected from the sensor, and to determine the recommendation of the do-not-disturb mode by applying the user context information including the motion information to the learning engine.

Further, the processor may be configured to further display, on the display, a user interface for setting a do-not-disturb mode release condition including a release condition based on a place based on the user's input for setting the do-not-disturb mode, and the processor may be configured to monitor a radio wave around the electronic equipment based on the setting of the do-not-disturb mode release condition, and to determine the satisfaction of the do-not-disturb mode release condition based on the place based on the radio wave.

Further, the processor may be configured to retrain the learning engine based on the result of monitoring whether the do-not-disturb mode of the user has been set.

Further, the processor may be configured to monitor a radio wave around the electronic equipment based on the user's input for setting the do-not-disturb mode, and to release the do-not-disturb mode based on the result of determining the leave of the place related to the place information based on the radio wave.

According to the embodiments of the present disclosure, it is possible to recommend the setting of the do-not-disturb mode based on the user's context, thereby improving the user's convenience of using the electronic equipment.

Further, according to the embodiments of the present disclosure, it is possible for the electronic equipment to accurately determine the user's context to recommend the setting of the do-not-disturb mode.

Further, according to the embodiments of the present disclosure, it is possible to improve the convenience by releasing and setting the do-not-disturb mode based on the place even if the time required for holding the do-not-disturb mode of the user is not determined.

Further, according to the embodiments of the present disclosure, it is possible to improve the convenience of releasing and setting the do-not-disturb mode for the user's schedule.

Further, according to the embodiments of the present disclosure, it is possible to improve the accuracy of the learning engine recommending the setting of the do-not-disturb mode.

Further, according to the embodiments of the present disclosure, it is possible for the server device to improve the learning model held by the server device by using a difference between the learning models received from the electronic equipment.

Further, according to the embodiments of the present disclosure, it is possible for the electronic equipment to release the do-not-disturb mode based on the place even without the setting of the do-not-disturb mode release condition, thereby improving the convenience of setting the do-not-disturb mode of the user.

Further, according to the embodiments of the present disclosure, it is possible for the electronic equipment to accurately determine the user's context to set and release the do-not-disturb mode, thereby improving the convenience of using the do-not-disturb mode of the user.

### BRIEF DESCRIPTION OF THE DRAWINGS

FIG. 1 is a block diagram illustrating a configuration of an electronic equipment according to an embodiment of the present disclosure.

FIG. 2 is a block diagram illustrating a configuration of a server device in which learning of an artificial neural network is possible according to an embodiment of the present disclosure.

FIG. 3 is an exemplary diagram of an environment capable of implementing an apparatus control method for recommending a do-not-disturb mode of an electronic equipment.

FIG. 4 is a diagram illustrating an embodiment in which an electronic equipment generates pattern information, and determines the recommendation of a do-not-disturb mode setting.

FIG. 5 is a diagram illustrating another embodiment in which an electronic equipment generates pattern information.

FIG. 6 is a diagram illustrating an embodiment in which an electronic equipment determines the recommendation of a do-not-disturb mode setting based on the context information of the user collected from message data or schedule data stored in a memory.

FIGS. 7 and 8 are diagrams illustrating an embodiment of an interface in which an electronic equipment recommends the setting of a do-not-disturb mode.

FIG. 9 is a diagram illustrating an embodiment of an interface that sets the release condition of a do-not-disturb mode.

FIG. 10 is a flowchart explaining an apparatus control method of an electronic equipment for recommending a do-not-disturb mode.

FIG. 11 is a flowchart explaining another apparatus control method of an electronic equipment for recommending a do-not-disturb mode.

FIG. 12 is a flowchart explaining an apparatus control method of an electronic equipment for releasing a do-not-disturb mode.

FIG. 13 is a flowchart explaining another apparatus control method of an electronic equipment for releasing a do-not-disturb mode.

FIG. 14 is a flowchart explaining an apparatus control method of an electronic equipment for setting and releasing a do-not-disturb mode.

### DETAILED DESCRIPTION

The embodiments disclosed in the present specification will be described in greater detail with reference to the accompanying drawings, and throughout the accompanying drawings, the same reference numerals are used to designate the same or similar components and redundant descriptions thereof are omitted. In the following description, the terms “module” and “unit” for referring to elements are assigned and used exchangeably in consideration of convenience of explanation, and thus, the terms per se do not necessarily have different meanings or functions. Wherever possible, the same reference numbers will be used throughout the drawings to refer to the same or like parts. In the following description, known functions or structures, which may confuse the substance of the present disclosure, are not explained. Further, the accompanying drawings are provided for more understanding of the embodiment disclosed in the present specification, but the technical spirit disclosed in the present disclosure is not limited by the accompanying drawings. It should be understood that all changes, equivalents, and alternatives included in the spirit and the technical scope of the present disclosure are included.

Although the terms first, second, third, and the like, may be used herein to describe various elements, components, regions, layers, and/or sections, these elements, components, regions, layers, and/or sections should not be limited by these terms. These terms are generally only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

The artificial intelligence (AI) is one field of computer science and information technology that studies methods to make computers mimic intelligent human behaviors such as reasoning, learning, self-improving and the like.

Further, artificial intelligence does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed

Specifically, the Machine Learning may be a technology for researching and constructing a system for learning, predicting, and improving its own performance based on empirical data and an algorithm for the same. The algorithms of the Machine Learning take a method of constructing a specific model in order to obtain the prediction or the determination based on the input data, rather than performing the strictly defined static program instructions.

Numerous machine learning algorithms have been developed for data classification in machine learning. Representative examples of such machine learning algorithms for data classification include a decision tree, a Bayesian network, a support vector machine (operation SVM), an artificial neural network (ANN), and so forth.

Decision tree refers to an analysis method that uses a tree-like graph or model of decision rules to perform classification and prediction.

Bayesian network may include a model that represents the probabilistic relationship (conditional independence) among a set of variables. Bayesian network may be appropriate for data mining via unsupervised learning.

SVM may include a supervised learning model for pattern detection and data analysis, heavily used in classification and regression analysis.

ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections, and acquires problem-solving capability as the strengths of synaptic interconnections are adjusted throughout training.

The terms ‘artificial neural network’ and ‘neural network’ may be used interchangeably herein.

An ANN may include a number of layers, each including a number of neurons. Further, the Artificial Neural Network may include the synapse for connecting between neuron and neuron.

An ANN may be defined by the following three factors: (1) a connection pattern between neurons on different layers; (2) a learning process that updates synaptic weights; and (3) an activation function generating an output value from a weighted sum of inputs received from a lower layer.

ANNs include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, based on the number of layers therein.

In general, a single-layer neural network may include an input layer and an output layer.

In general, a multi-layer neural network may include an input layer, one or more hidden layers, and an output layer.

The input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. Input signals between the neurons are summed together after being multiplied by corresponding connection strengths (synaptic weights), and if this sum exceeds a threshold value of a corresponding neuron, the neuron may be activated and output an output value obtained through an activation function.

In the meantime, a deep neural network with a plurality of hidden layers between the input layer and the output layer may be the most representative type of artificial neural network which enables deep learning, which is one machine learning technique.

An ANN may be trained using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An artificial neural network trained using training data may classify or cluster inputted data according to a pattern within the inputted data.

Throughout the present specification, an artificial neural network trained using training data may be referred to as a trained model.

Hereinbelow, learning paradigms of an artificial neural network will be described in detail.

Learning paradigms, in which an artificial neural network operates, may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network may be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels. In this case, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent may determine what action to choose at each time instance, the agent may find an optimal path to a solution solely based on experience without reference to data.

Reinforcement learning may be performed mainly through a Markov decision process.

Markov decision process consists of four stages: first, an agent is given a condition containing information required for performing a next action; second, how the agent behaves under the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters may be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (operation SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Accordingly in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters may be set to optimal values that provide a stable learning rate and accuracy.

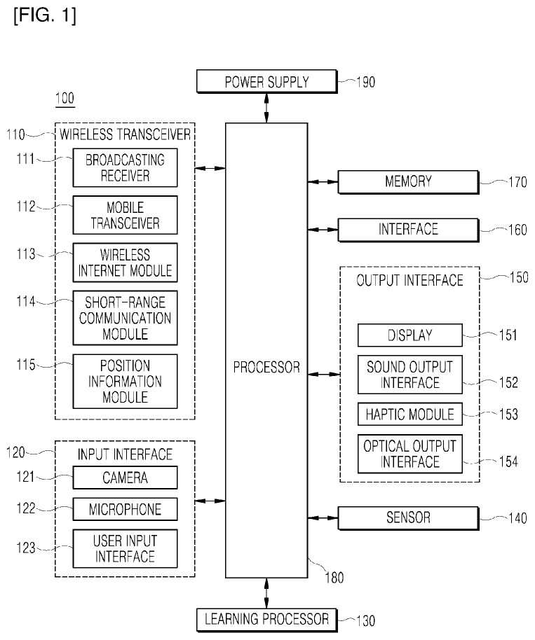

FIG. 1 is a block diagram illustrating the configuration of a terminal 100 according to an embodiment of the present disclosure.

The terminal 100 may be implemented as a stationary terminal and a mobile terminal, such as a mobile phone, a projector, a mobile phone, a smartphone, a laptop computer, a terminal for digital broadcast, a personal digital assistant (PDA), a portable multimedia player (PMP), a navigation system, a slate PC, a tablet PC, an ultrabook, a wearable device (for example, a smartwatch, a smart glass, and a head mounted display (HMD)), a set-top box (operation STB), a digital multimedia broadcast (DMB) receiver, a radio, a laundry machine, a refrigerator, a desktop computer, a digital signage.

That is, the electronic equipment 100 may be implemented as various home appliances used at home and also applied to a fixed or mobile robot.

The terminal 100 may perform a function of a voice agent. The voice agent may be a program which recognizes a voice of the user and outputs a response appropriate for the recognized voice of the user as a voice.

Referring to FIG. 1, the terminal 100 may include a wireless transceiver 110, an input interface 120, a learning processor 130, a sensor 130, an output interface 150, an interface 160, a memory 170, a processor 180, and a power supply 190.

A learning model (a trained model) may be loaded in the electronic equipment 100.

In the meantime, the learning model may be implemented by hardware, software, or a combination of hardware and software. When a part or all of the learning model is implemented by software, one or more commands which configure the learning model may be stored in the memory 170.

The wireless transceiver 110 may include at least one of a broadcasting receiver 111, a mobile transceiver 112, a wireless internet module 113, a short-range communication module 114, or a position information module 115.

The broadcasting receiver 111 receives a broadcasting signal and/or broadcasting related information from an external broadcasting management server through a broadcasting channel.

The mobile transceiver 112 may transmit/receive a wireless signal to/from at least one of a base station, an external terminal, or a server on a mobile communication network established according to the technical standards or communication methods for mobile communication (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A)).

The wireless internet module 113 refers to a module for wireless internet access and may be built in or external to the electronic equipment 100. The wireless internet module 113 may be configured to transmit/receive a wireless signal in a communication network according to wireless internet technologies.

The wireless internet technologies may include Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A).

The short-range communication module 114 may support Short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, or Wireless Universal Serial Bus (USB) technologies.

The place information module 115 is a module for obtaining the position (or the current position) of a mobile terminal, and its representative examples include a global positioning system (GPS) module or a Wi-Fi module. For example, the mobile terminal may obtain its position by using a signal transmitted from a GPS satellite through the GPS module.

The input interface 120 may include a camera 121 which inputs an image signal, a microphone 122 which receives an audio signal, and a user input interface 123 which receives information from the user.

Voice data or image data collected by the input interface 120 is analyzed to be processed as a control command of the user.

The input interface 120 may obtain training data for training a model and input data used to obtain an output using the trained model.

The input interface 120 may obtain input data which is not processed, and, in this case, the processor 180 or the learning processor 130 pre-processes the obtained data to generate training data to be input to the model learning or pre-processed input data.

In this case, the pre-processing on the input data may refer to extracting of an input feature from the input data.

The input interface 120 is for inputting of image information (or signal), audio information (or signal), data, or information being inputted from a user. For example for inputting of the image information, the terminal 100 may be provided with one or more cameras 121.

The camera 121 processes an image frame such as a still image or a moving image obtained by an image sensor in a video call mode or a photographing mode. The processed image frame may be displayed on the display 151 or stored in the memory 170.

The microphone 122 processes an external sound signal as electrical voice data. The processed voice data may be utilized in various forms in accordance with a function which is being performed by the electronic equipment 100 (or an application program which is being executed). In the meantime, in the microphone 122, various noise removal algorithms which remove a noise generated during the process of receiving the external sound signal may be implemented.

The user input interface 123 receives information from the user and when the information is input through the user input interface 123, the processor 180 may control the operation of the electronic equipment 100 so as to correspond to the input information.

The user input interface 123 may include a mechanical input interface (or a mechanical key, for example, a button located on a front, rear, or side surface of the electronic equipment 100, a dome switch, a jog wheel, or a jog switch) and a touch type input interface. For example, the touch type input interface may be formed by a virtual key, a soft key, or a visual key which is disposed on the touch screen through a software process or a touch key which is disposed on a portion other than the touch screen.

The learning processor 130 learns the model configured by an artificial neural network using the training data.

Specifically, the learning processor 130 allows the artificial neural network to repeatedly learn using various learning techniques described above to determine optimized model parameters of the artificial neural network.

In this specification, the artificial neural network which is trained using training data to determine parameters may be referred to as a learning model or a trained model.

In this case, the learning model may be used to deduce a result for the new input data, rather than the training data.

The learning processor 130 may be configured to receive, classify, store, and output information to be used for data mining, data analysis, intelligent decision making, and machine learning algorithm and techniques.

The learning processor 130 may include one or more memory units configured to store data which is received, detected, sensed, generated, previously defined, or output by another component, device, the terminal, or a device which communicates with the terminal.

The learning processor 130 may include a memory which is combined with or implemented in the terminal. In some exemplary embodiments, the learning processor 130 may be implemented using the memory 170.

Selectively or additionally, the learning processor 130 may be implemented using a memory related to the terminal, such as an external memory which is directly coupled to the terminal or a memory maintained in the server which communicates with the terminal.

According to another exemplary embodiment, the learning processor 130 may be implemented using a memory maintained in a cloud computing environment or other remote memory positions accessible by the terminal via a communication method such as a network.

The learning processor 130 may be configured to store data in one or more databases to identify, index, categorize, manipulate, store, search, and output data in order to be used for supervised or non-supervised learning, data mining, predictive analysis, or used in the other machine. Here, the database may be implemented using the memory 170, a memory 230 of the learning device 200, a memory maintained in a cloud computing environment or other remote memory positions accessible by the terminal via a communication method such as a network.

Information stored in the learning processor 130 may be used by the processor 180 or one or more controllers of the terminal using an arbitrary one of different types of data analysis algorithms and machine learning algorithms

Examples of algorithm include k-nearest neighbor systems, fuzzy logic (for example, likelihood theory), neural networks, Boltzmann machines, vector quantization, pulse neural networks, support vector machines, maximum margin classifiers, hill climbing, induction logic system, Bayesian network, Pertinet (for example, a finite state machine, a millimachine, a Moore finite state machine), a classifier tree (for example, a perceptron tree, a support vector tree, a Markov tree, a decision tree forest, an arbitrary forest), decoding models and systems, artificial fusion, sensor fusion, image fusion, reinforcement learning, augmented reality, pattern recognition, an automated plan, and so forth.

The processor 180 may determine or predict at least one executable operation of the terminal based on information which is determined or generated using the data analysis and the machine learning algorithm. To this end, the processor 180 may request, search, receive, or utilize the data of the learning processor 130 and control the terminal to execute a predicted operation or a desired operation among the at least one executable operation.

The processor 180 may perform various functions which implement intelligent emulation (that is, a knowledge based system, an inference system, and a knowledge acquisition system). This may be applied to various types of systems (for example, a fuzzy logic system) including an adaptive system, a machine learning system, and an artificial neural network.

The processor 180 may include sub modules which enable operations involving voice and natural language voice processing, such as an I/O processing module, an environmental condition module, a speech to text (operation STT) processing module, a natural language processing module, a workflow processing module, and a service processing module.

The sub modules may have an access to one or more systems or data and a model, or a subset or a super set those of them in the terminal. Further, each of the sub modules may provide various functions including a glossarial index, user data, a workflow model, a service model, and an automatic speech recognition (ASR) system.

According to another exemplary embodiment, another aspect of the processor 180 or the terminal may be implemented by the above-described sub module, a system, data, and a model.

In some exemplary embodiments, based on the data of the learning processor 130, the processor 180 may be configured to detect and sense requirements based on contextual conditions expressed by user input or natural language input or user's intention.

The processor 180 may actively derive and obtain information required to completely determine the requirement based on the contextual conditions or the user's intention. For example, the processor 180 may actively derive information required to determine the requirements, by analyzing past data including historical input and output, pattern matching, unambiguous words, and input intention.

The processor 180 may determine a task flow to execute a function responsive to the requirements based on the contextual condition or the user's intention.

The processor 180 may be configured to collect, sense, extract, detect and/or receive a signal or data which is used for data analysis and a machine learning task through one or more sensing components in the terminal, to collect information for processing and storing in the learning processor 130.

The information collection may include sensing information by a sensor, extracting of information stored in the memory 170, or receiving information from other electronic equipment, an entity, or an external storage device through a transceiver.

The processor 180 collects usage history information from the terminal and stores the information in the memory 170.

The processor 180 may determine best matching to execute a specific function using stored usage history information and predictive modeling.

The processor 180 may receive or sense surrounding environment information or other information through the sensor 140.

The processor 180 may receive a broadcasting signal and/or broadcasting related information, a wireless signal, or wireless data through the wireless transceiver 110.

The processor 180 may receive image information (or a corresponding signal), audio information (or a corresponding signal), data, or user input information from the input interface 120.

The processor 180 may collect the information in real time, process or classify the information (for example, a knowledge graph, a command policy, a personalized database, or a conversation engine) and store the processed information in the memory 170 or the learning processor 130.

When the operation of the terminal is determined based on data analysis and a machine learning algorithm and technology, the processor 180 may control the components of the terminal to execute the determined operation. Further, the processor 180 may control the electronic equipment in accordance with the control command to perform the determined operation.

When a specific operation is performed, the processor 180 analyzes history information indicating execution of the specific operation through the data analysis and the machine learning algorithm and technology and updates the information which is previously learned based on the analyzed information.

Accordingly the processor 180 may improve precision of a future performance of the data analysis and the machine learning algorithm and technology based on the updated information, together with the learning processor 130.

The sensor 140 may include one or more sensors which sense at least one of information in the mobile terminal, surrounding environment information around the mobile terminal, or user information.

For example, the sensor 140 may include at least one of a proximity sensor, an illumination sensor, a touch sensor, an acceleration sensor, a magnetic sensor, a G-sensor, a gyroscope sensor, a motion sensor, an RGB sensor, an infrared (IR) sensor, a finger smay sensor, an ultrasonic sensor, an optical sensor (for example, a camera 121), a microphone 122, a battery gauge, an environment sensor (for example, a barometer, a hygrometer, a thermometer, a radiation sensor, a thermal sensor, or a gas sensor), or a chemical sensor (for example, an electronic nose, a healthcare sensor, or a biometric sensor). On the other hand, the terminal 100 disclosed in the present disclosure may combine various kinds of information sensed by at least two of the above-mentioned sensors and may use the combined information.

The output interface 150 generates outputs related to vision, auditory, or tactile and may include at least one of a display 151, a sound output interface 152, a haptic module 153, or an optical output interface 154.

The display 151 displays (outputs) information processed in the electronic equipment 100. For example, the display 151 may display execution screen information of an application program driven in the electronic equipment 100 and user interface (UI) and graphic user interface (GUI) information in accordance with the execution screen information.

The display 151 forms a mutual layered structure with a touch sensor or is formed integrally to be implemented as a touch screen. The touch screen may simultaneously serve as a user input interface 123 which provides an input interface between the electronic equipment 100 and the user and provide an output interface between the electronic equipment 100 and the user.

The sound output interface 152 may output audio data received from the wireless transceiver 110 or stored in the memory 170 in a call signal reception mode, a phone-call mode, a recording mode, a voice recognition mode, or a broadcasting reception mode.

The sound output interface 152 may include at least one of a receiver, a speaker, or a buzzer.

The haptic module 153 may generate various tactile effects that the user may feel. A representative example of the tactile effect generated by the haptic module 153 may be vibration.

The optical output interface 154 outputs a signal for notifying occurrence of an event using light of a light source of the electronic equipment 100. Examples of the event generated in the electronic equipment 100 may be message reception, call signal reception, missed call, alarm, schedule notification, email reception, and information reception through an application.

The interface 160 serves as a passage with various types of external devices which are connected to the electronic equipment 100. The interface 160 may include at least one of a wired/wireless headset port, an external charger port, a wired/wireless data port, a memory card port, a port which connects a device equipped with an identification module, an audio input/output (I/O) port, a video input/output (I/O) port, or an earphone port. The electronic equipment 100 may perform appropriate control related to the connected external device in accordance with the connection of the external device to the interface 160.

In the meantime, the identification module is a chip in which various information for authenticating a usage right of the electronic equipment 100 is stored and includes a user identification module (UIM), a subscriber identify module (operation SIM), and a universal subscriber identity module (USIM). The device with an identification module (hereinafter, “identification device”) may be manufactured as a smart card. Accordingly the identification device may be connected to the electronic equipment 100 through the interface 160.

The memory 170 stores data which supports various functions of the electronic equipment 100.

The memory 170 may store various application programs (or applications) driven in the electronic equipment 100, data for the operation of the electronic equipment 100, commands, and data (for example, at least one algorithm information for machine learning) for the operation of the learning processor 130.

The memory 170 may store the model which is learned in the learning processor 130 or the learning device 200.

If necessary, the memory 170 may store the trained model by dividing the model into a plurality of versions depending on a training timing or a training progress.

In this case, the memory 170 may store input data obtained from the input interface 120, learning data (or training data) used for model learning, a learning history of the model, and so forth.

In this case, the input data stored in the memory 170 may be not only data which is processed to be suitable for the model learning but also input data itself which is not processed.

Further to the operation related to the application program, the processor 180 may generally control an overall operation of the electronic equipment 100. The processor 180 may process a signal, data, or information which is input or output through the above-described components or drives the application programs stored in the memory 170 to provide or process appropriate information or functions to the user.

Further, in order to drive the application program stored in the memory 170, the processor 180 may control at least some of components described with reference to FIG. 1. Moreover, the processor 180 may combine and operate at least two of components included in the electronic equipment 100 to drive the application program.

In the meantime, as described above, the processor 180 may control an operation related to the application program and an overall operation of the electronic equipment 100. For example, when the state of the terminal satisfies a predetermined condition, the processor 180 may execute or release a locking state which restricts an input of a control command of a user for the applications.

The power supply 190 is applied with external power or internal power to supply the power to the components included in the terminal 100 under the control of the processor 180. The power supply 190 includes a battery and the battery may be an embedded battery or a replaceable battery.

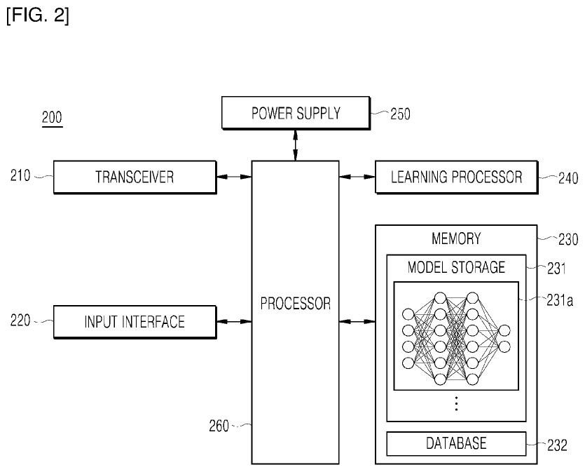

FIG. 2 is a block diagram illustrating a configuration of a learning device 200 for an artificial neural network according to an embodiment of the present disclosure.

The learning device 200 is a device or a server which is separately configured at the outside of the electronic equipment 100 and may perform the same function as the learning processor 130 of the electronic equipment 100.

That is, the learning device 200 may be configured to receive, classify, store, and output information to be used for data mining, data analysis, intelligent decision making, and machine learning algorithms Here, the machine learning algorithm may include a deep learning algorithm.

The learning device 200 may communicate with at least one electronic equipment 100 or derive a result by analyzing or learning the data on behalf of the electronic equipment 100. Here, the meaning of “on behalf of the other device” may be distribution of a computing power by means of distributed processing.

The learning device 200 of the artificial neural network is various devices for learning an artificial neural network and normally, refers to a server, and also referred to as a learning device or a learning server.

Specifically, the learning device 200 may be implemented not only by a single server, but also by a plurality of server sets, a cloud server, or a combination thereof.

That is, the learning device 200 is configured as a plurality of learning devices to configure a learning device set (or a cloud server) and at least one learning device 200 included in the learning device set may derive a result by analyzing or learning the data through the distributed processing.

The learning device 200 may transmit a model trained by the machine learning or the deep learning to the electronic equipment 100 periodically or upon the request.

Referring to FIG. 2, the learning device 200 may include a transceiver 210, an input interface 220, a memory 230, a learning processor 240, a power supply 250, a processor 260, and so forth.

The transceiver 210 may correspond to a configuration including the wireless transceiver 110 and the interface 160 of FIG. 1. That is, the transceiver may transmit and receive data with the other device through wired/wireless communication or an interface.

The input interface 220 is a configuration corresponding to the input interface 120 of FIG. 1 and may receive the data through the transceiver 210 to obtain data.

The input interface 220 may obtain input data for acquiring an output using training data for model learning and a trained model.

The input interface 220 may obtain input data which is not processed, and, in this case, the processor 260 may pre-process the obtained data to generate training data to be input to the model learning or pre-processed input data.

In this case, the pre-processing on the input data performed by the input interface 220 may refer to extracting of an input feature from the input data.

The memory 230 is a configuration corresponding to the memory 170 of FIG. 1.

The memory 230 may include a model storage 231, a database 232, and so forth.

The model storage 231 stores a model (or an artificial neural network 231a) which is learning or trained through the learning processor 240 and when the model is updated through the learning, stores the updated model.

If necessary, the model storage 231 stores the trained model by dividing the model into a plurality of versions depending on a training timing or a training progress.

The artificial neural network 231a illustrated in FIG. 2 is one example of artificial neural networks including a plurality of hidden layers but the artificial neural network of the present disclosure is not limited thereto.

The artificial neural network 321a may be implemented by hardware, software, or a combination of hardware and software. When a part or all of the artificial neural network 321a is implemented by the software, one or more commands which configure the artificial neural network 321a may be stored in the memory 230.

The database 232 stores input data obtained from the input interface 220, learning data (or training data) used to learn a model, a learning history of the model, and so forth.

The input data stored in the database 232 may be not only data which is processed to be suitable for the model learning but also input data itself which is not processed.

The learning processor 240 is a configuration corresponding to the learning processor 130 of FIG. 1.

The learning processor 240 may train (or learn) the artificial neural network 231a using training data or a training set.

The learning processor 240 may immediately obtain data which is obtained by pre-processing input data obtained by the processor 260 through the input interface 220 to learn the artificial neural network 321a or obtain the pre-processed input data stored in the database 232 to learn the artificial neural network 231a.

Specifically, the learning processor 240 repeatedly may train the artificial neural network 321a using various learning techniques described above to determine optimized model parameters of the artificial neural network 231a.

In this specification, the artificial neural network which is trained using training data to determine parameters may be referred to as a learning model or a trained model.

Here, the trained model may infer result values even while being installed in a learning device 200 of an artificial neural net and may be transferred to and installed in another device such as a terminal 100 by a transceiver 210.

Further, when the trained model is updated, the updated trained model may be transferred to and installed in another device such as the terminal 100 through the transceiver 210.

The power supply 250 is a configuration corresponding to the power supply 190 of FIG. 1.

A redundant description for corresponding configurations will be omitted.

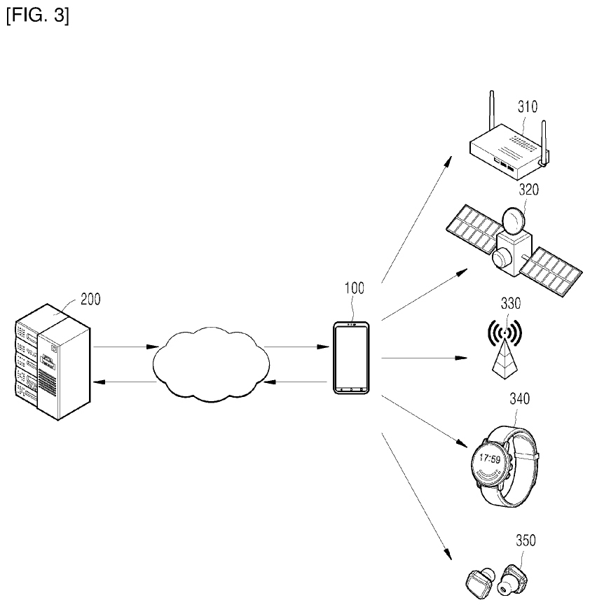

FIG. 3 is an exemplary diagram of an environment capable of implementing a method of recommending a do-not-disturb mode of the electronic equipment 100 according to an embodiment of the present disclosure. In the following description, description of parts that are the same as those in FIGS. 1 and 2 will be omitted.

Referring to FIG. 3, an environment for implementing the method of recommending the do-not-disturb mode of the electronic equipment 100 according to an embodiment may include the electronic equipment 100, a server device 200 capable of training a learning model based on machine learning, and a network configured to connect them to each other.

The electronic equipment 100 may include a configuration as in FIG. 1, may be a mobile device that may be moved while being held by a user, and for example, may be any one of various devices such as a smartphone, a tablet PC, a smart watch, a notebook, and a PDA.

The electronic equipment 100 may transmit and receive information from the server device 200 or the Internet through a mobile communication network such as CDMA, GSM, WCDMA, LTE, or 5G mobile communication (5G) as well as Wi-Fi.

The electronic equipment 100 may provide an environment capable of setting or releasing a do-not-disturb mode through a Graphical User Interface (UI) in various operating system (OS) environments.

The electronic equipment 100 may collect user context information including time information and place information from a sensor, a communication module, or a memory mounted in the electronic equipment 100 of the user, and will be described in detail below.

The electronic equipment 100 may include various sensor modules such as a position sensor such as a GPS, a gyroscope sensor, a motion sensor, an acceleration sensor, an RGB sensor, an infrared sensor, an environmental sensor (temperature sensor, humidity sensor, or the like), a magnetic sensor, a touch sensor, a proximity sensor, an illuminance sensor, and a depth sensor.

The electronic equipment 100 may receive time information, place information, motion information, and the like from external devices, and the external devices may include a wireless Access Point (AP) 310, a GPS satellite 320, a base station 330, a smart watch 340, a smart ear buds 350, a vehicle (not illustrated), a smart home appliance (not illustrated), and the like, and the type thereof is not particularly limited.

The electronic equipment 100 may be connected with some of the external devices through wired or wireless communication, and for example, the communication connection between the electronic equipment 100 and some devices 310, 340, 350 may be established through Bluetooth, Zigbee, Wi-Di, or Zing as wireless communication, and through the connection of USB, FireWire (IEEE 1394), or the like as wired communication.

The external device may also be connected with the electronic equipment 100 by wired or wireless communication based on a specific interface method, and for example, if the external device is a vehicle (not illustrated), the electronic equipment 100 and the external device may be connected through an interface such as Android Auto, Apple CarPlay, or Mirrorlink, and may also be connected based on an interface such as a Mirrorlink or a Wi-Di if the external device is a smart home appliance.

The electronic equipment 100 may determine whether to recommend a do-not-disturb mode by inputting the collected user context information into a machine learning-based or pattern-based learning engine, and recommend the setting of the do-not-disturb mode to the user based on the determination of the learning engine.

A method of recommending the setting of the do-not-disturb mode to the user and a method of setting the release condition by the electronic equipment 100 based on the determination of the learning engine will be described in detail below.

The server device 200 may include a configuration as in FIG. 2, and in an embodiment, may train the learning engine based on machine learning so as to recommend the setting of the do-not-disturb mode according to the context information by using training data labeled with data having executed a do-not-disturb mode function under the conditions of various context information by a plurality of users or a specific user.

In another embodiment, in the server device 200, the training data for training the learning engine based on machine learning may be training data labeled with the data having executed the do-not-disturb mode function under the conditions of time information, place information, or context information extracted from message data or schedule data.

In another embodiment, the server device 200 may train the learning engine based on machine learning so as to determine the user's context according to the context information by using the training data labeled with the user's context under the conditions of various context information. Accordingly, the result of applying the context information to the corresponding learning engine by the electronic equipment 100 may be the determination on the user's context, for example, a context such as ‘at work,’ ‘on exercise,’ ‘rest at home,’ or ‘spending time with friends outside,’ and the electronic equipment 100 may also recommend the setting of the do-not-disturb mode to the user based on the determined context.

The learning engine is described in detail below.

In an embodiment, the electronic equipment 100 may recommend the setting of the do-not-disturb mode to the user based on the result of applying the context information of the user to the learning engine that has set, as a determination reference, pattern information generated based on the learning engine based on machine learning received from the server device 200 or the learning information generated by the electronic equipment 100.

In another embodiment, the electronic equipment 100 may also apply the context information after training the learning engine again based on the result of monitoring whether the user of the electronic equipment 100 has set according to the recommendation of setting the do-not-disturb mode of the learning engine based on machine learning received from the server device 200 under the conditions of various context information.

Referring back to FIG. 1, a configuration of the electronic equipment 100 will be described. In the following description, the description of the parts overlapping with the above-described parts will be omitted.

The electronic equipment 100 according to an embodiment of the present disclosure may include the memory 170 that may be electrically connected with the processor 180 and may store intermediate or final data of instructions executed in the processor 180 or processes executed in the processor 180.

The processor 180 may collect user context information based on time information and place information generated from at least one of the data collected through the sensor 140 or the communication module 110 or the data stored in the memory 170.

The electronic equipment 100 according to an embodiment of the present disclosure may include the communication module 110 including the position information module 115 capable of receiving the position information from a GPS satellite and the sensor 140 composed of various sensors capable of sensing physical information, and include the processor 180 capable of controlling these operations.

The sensor 140 may sense physical information, and the communication module 110 may receive external information through a network.

The processor 180 may generate place information based on the sensed physical information or the received external information and collect it as user context information. For example, the processor 180 may generate, as the place information, a GPS 320 coordinate of the place where the electronic equipment 100 has been positioned for a predetermined time, a network name (Service Set : SSID) or a media access control (MAC) address of the AP 310 that the electronic equipment 100 has accessed for a predetermined time, and a cell ID of a mobile communication base station (or repeater) 330 that the electronic equipment 100 has accessed through the communication module 110 for a predetermined time. The repeater may have a unique identifier other than the cell ID, and the electronic equipment 100 may extract the unique identifier of the repeater accessed through communication with the repeater to generate it as the place information.

The place information does not mean only the longitude and latitude coordinates of a geographic specific position, and as long as it is information that may distinguish the corresponding position in relation to the corresponding position (or an area of a certain range including the corresponding position), may include a cell ID, an identifier of a repeater, a network name of an AP, and the like, and the type thereof is not particularly limited.

The processor 180 may generate time information based on the sensed physical information or the received external information and collect it as user context information. For example, the processor 180 may generate, as the time information, the time at which the electronic equipment 100 has been positioned at a specific place (the time at which the user has arrived at the specific place, the time at which the user has stayed at the specific place, or the like) based on the time synchronized with the base station 330 through the communication module 110.

In an embodiment, the processor 180 may collect the time information and the place information from data stored in the memory 170. For example, the processor 180 may perform text analysis on the message data or schedule data stored in the memory 170 to collect the extracted meeting time as the time information and to collect the extracted meeting place as the place information.

In another embodiment, the processor 180 may collect the user context information based on at least one of biometric information received from the connected devices 340, 350 or measured through the sensor 140 or motion information related to the user's movement. The biometric information may be electrocardiogram (ECG), heart rate (HR), blood pressure (BP) information, and the like, and the motion information may be time series data measured by the electronic equipment 100 or a gyro sensor and an acceleration sensor of the device connected with the electronic equipment 100. The biometric information and the motion information are not limited to the above-described types. For example, the heart rate measured during exercise or sleep of the user may be collected as user context information along with the time information and the place information as the biometric information. Alternatively, the movement measured during exercise or sleep of the user may be collected as user context information along with the time information and the place information as the motion information.

The processor 180 may determine whether to recommend the do-not-disturb mode to the user by applying the user context information to the learning engine that has set the learning engine based on machine learning or the pattern information generated in the electronic equipment 100 as the determination reference.

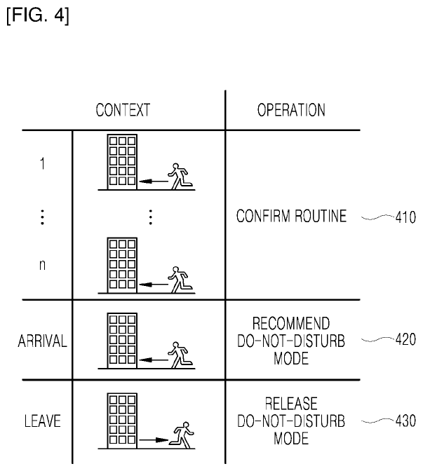

FIG. 4 is a diagram illustrating an embodiment in which the electronic equipment 100 according to an embodiment of the present disclosure generates learning information, generates pattern information based on the generated learning information, and determines the recommendation for setting a do-not-disturb mode.

If the place where the user has been positioned and the time at which the user has been positioned at the corresponding place are suitable for a predetermined reference, the electronic equipment 100 may generate the place where the user has been positioned and the time at which the user has been positioned at the corresponding place as the learning information including the place information and the time information.

For example, if the user visits a fitness center after work on weekdays 410 to stay for a certain time, the GPS 320 coordinates of the corresponding fitness center, the measurement position using the wireless information of the mobile communication base station 330, the cell ID of the area where the fitness center has been positioned or the identifier of the repeater 330, the network name of the AP 310, and the like may be generated as the place information, and the day of the week, the time, and the like stayed in the fitness center may be generated as the time information.

In another embodiment, the processor 180 may generate learning information based on at least one of the biometric information received from the connected devices 340, 350 or measured through the sensor 140 or motion information related to the user's movement.

For example, the heart rate measured during sleep or exercise from the wearable devices 340, 350 worn by the user may be generated as the learning information together with the place where the user has been positioned and the time at which the user has been positioned at the corresponding place. If the user visits the fitness center after work on weekdays 410 to exercise for a certain time, learning information including the heart rate and the movement of the user as the biometric information and the motion information, respectively, may be generated together with the time information and the place information. Alternatively, learning information including the heart rate and the movement measured during sleep of the user as the biometric information and the motion information, respectively, may be generated.

The electronic equipment 100 may classify and analyze at least one learning information including the time information or the place information, generate the pattern information based on common time information and place information of the learning information having repeatability, and set the generated pattern information as the determination reference of the learning engine. Thereafter, the electronic equipment 100 may apply the collected user context information to the learning engine, and determine the recommendation of the do-not-disturb mode if the collected user context information has the commonality of a predetermined reference or more with the pattern information.

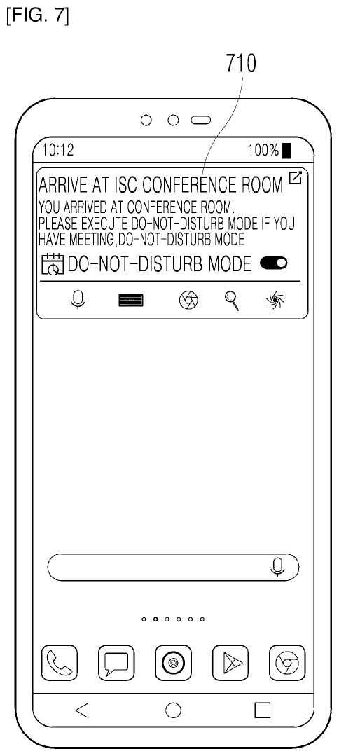

For example, the pattern information generated based on the learning information including the place information related to the position of the fitness center repeatedly visited by the user in a similar time zone after work on weekdays 410 and the time information related to the time zone of stay may be set as the determination reference of the learning engine. Thereafter, if the user visits the corresponding fitness center at a similar time zone within a predetermined reference with the time information of the pattern information (or if visiting for a certain time or more) 420, the electronic equipment 100 may display the interface as in FIG. 7 capable of setting the do-not-disturb mode on the display 151.

In an embodiment, the electronic equipment 100 may determine the recommendation of the do-not-disturb mode setting by applying the user context information including the biometric information received from the connected devices 340, 350 to the learning engine based on the pattern.

For example, the pattern information set as the determination reference of the learning engine may include the biometric information of the user stored in relation with the corresponding place information together with the place information related to the position of a specific fitness center. If the user visits the corresponding fitness center, and the heart rate received from the connected device is the heart rate or more included in the pattern information, the electronic equipment 100 may determine the recommendation of the do-not-disturb mode setting.

In another embodiment, the electronic equipment 100 may determine the recommendation of the do-not-disturb mode setting by applying the user context information including the biometric information received from the connected devices 340, 350 to the learning engine based on machine learning.

For example, the electronic equipment 100 may apply the user context information including the biometric information to the learning engine trained by using training data labeled with the user's context under the conditions of various context information, and determine the recommendation of the do-not-disturb mode setting if it has been determined as a context where the user is ‘on exercise’ by the learning engine.

In another embodiment, the electronic equipment 100 may determine the recommendation of the do-not-disturb mode setting by applying the user context information including the motion information related to the movement of the user received from the connected devices 340, 350 to the learning engine.

For example, the pattern information set as the determination reference of the learning engine may include the motion information related to the movement of the user stored in relation with the corresponding place information together with the place information related to the position of the specific fitness center. If the user visits the corresponding fitness center, and the motion information received from the connected device is similar to the motion information included in the pattern information, the electronic equipment 100 may determine the recommendation of the do-not-disturb mode setting.

In another embodiment, the electronic equipment 100 may determine the recommendation of the do-not-disturb mode setting if it has been determined as a context where the user is ‘on exercise’ by the learning engine by applying the user context information including the motion information to the learning engine based on machine learning.

Referring to FIG. 4, an embodiment in which the electronic equipment 100 releases the do-not-disturb mode based on the pattern information set as the determination reference of the learning engine will be described.

The electronic equipment 100 may determine whether to release the do-not-disturb mode by applying the user context information collected after the do-not-disturb mode has been set to the learning engine.

In an embodiment, the do-not-disturb mode may be set after the user has been positioned at the position related to the place information of the pattern information set as the determination reference of the learning engine, and then, the electronic equipment 100 may release the do-not-disturb mode if the place information included in the collected user context information is related to the position different from that of the pattern information (out of a predetermined reference). Alternatively, after the user has left a certain time at the position related to the pattern information, the do-not-disturb mode may be released.

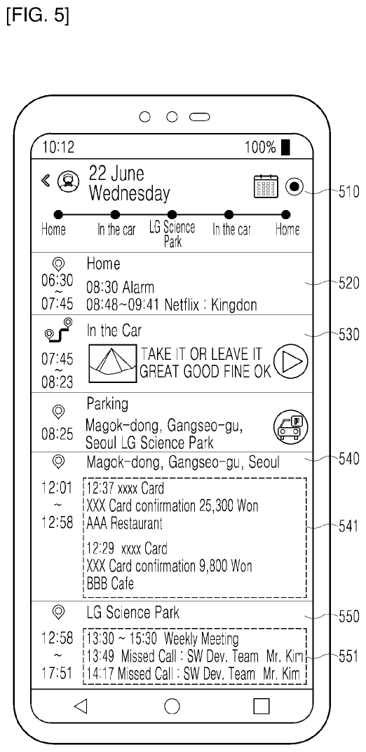

FIG. 5 is a diagram illustrating another embodiment in which the electronic equipment 100 according to an embodiment of the present disclosure generates learning information and generates pattern information based on the generated learning information.

FIG. 5 is an embodiment in which the electronic equipment 100 graphically displays data in which the route moved by the user on a specific date and the usage history of the electronic equipment 100 have been stored in the memory 170.

The electronic equipment 100 may generate the learning information based on the usage history 510 to 551 of the electronic equipment 100 of the user related to the corresponding time together with the place where the electronic equipment 100 according to the user's activity has been positioned and the time at which the user has been positioned at the corresponding place.

The electronic equipment 100 may store, as data, the usage history of the electronic equipment 100 of the user as in FIG. 5, and then generate it as the pattern information if the usage history related to a specific place has repeatability within a predetermined reference.

For example, if the electronic equipment 100 and the vehicle have been connected in a wireless communication method such as Bluetooth, mirror link, Android auto, or carplay while the user moves to the same position at a similar time zone every morning in his/her owned vehicle 530, the electronic equipment 100 may generate, as the pattern information, the wireless communication ID and the connection duration of the connected vehicle.

The electronic equipment 100 may generate the pattern information based on the message 541 or the schedule information 551 stored in the memory 170.

For example, if the usage history of a missed call exists for a time related to the schedule information 551 stored in the memory 170 and the corresponding schedule information is repeatedly stored at a specific period, the pattern information may be generated based on the time and the position related to the corresponding schedule information.

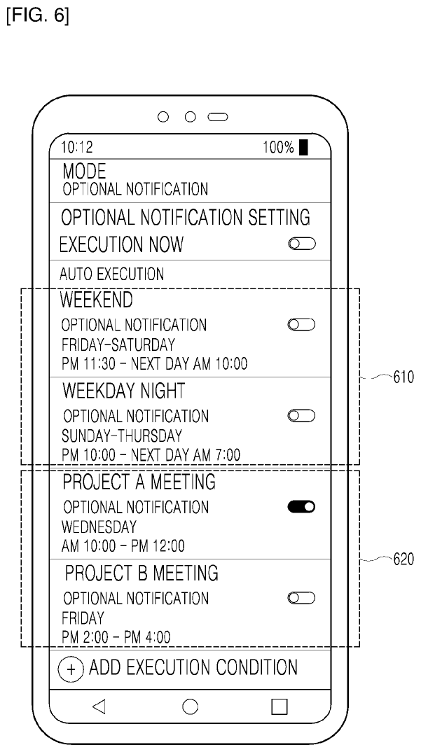

FIG. 6 is a diagram illustrating an embodiment in which the electronic equipment 100 according to an embodiment of the present disclosure collects user context information from message data or schedule data stored in a memory, and determines the recommendation of a do-not-disturb mode setting based on the collected user context information.

The electronic equipment 100 may receive, from the server device 200, the learning engine based on machine learning trained in advance so as to determine whether it is a context where the do-not-disturb mode is required based on time information, place information, or context information.

In an embodiment, the learning engine based on machine learning may be training data labeled with data having executed a do-not-disturb mode function under condition of the time information, the place information, or the context information extracted from the message data or the schedule data. In this case, the time information may be information obtained by converting the extracted time data into a time interval (for example, 1 hour) rather than a specific time zone (for example, 9 am to 10 am), the place information may be category information such as ‘home,’ or ‘work’ rather than a specific GPS coordinate, and the context information may be category information such as ‘conference’ or ‘meeting.’

In another embodiment, the learning engine may be a learning engine trained to determine the user's context according to the context information by using the training data labeled with the user's context under the conditions of various context information.

The electronic equipment 100 may input the extracted time information, place information, or context information to the learning engine based on machine learning by performing text analysis on the message data or the schedule data. If the learning engine has determined that the recommendation of the do-not-disturb mode setting is required or has determined as a context that the setting of the do-not-disturb mode is required, the electronic equipment 100 may display, on the display 151, the interface capable of setting the do-not-disturb mode together with the time information, the place information, or the context information extracted from the user context information 620.

Accordingly, the user may easily set the do-not-disturb mode without setting the do-not-disturb mode by inputting time and place for the schedule included in the schedule management application or the message one by one.

In another embodiment, the electronic equipment 100 may train the learning engine based on machine learning received from the server device 200.

For example, if the user has ignored the notification of the electronic equipment 100 or if the user has performed an aggressive rejection operation (for example, an operation of rejecting a call), the schedule information related to the place where the user has been positioned, the time of having ignored the notification, the time of having rejected the call, or the like are stored as the user context information, and this may be used as the training data of the learning engine.

Alternatively, the electronic equipment 100 may retrain the learning engine based on the user's response to the recommendation of the do-not-disturb mode setting displayed on the display 151. For example, after displaying the recommendation of the do-not-disturb mode setting on the display 151 based on the determination of the learning engine based on machine learning trained in advance so as to determine whether it is a context where the do-not-disturb mode is required, the user context information of whether the user sets the do-not-disturb mode and the point of time of recommendation may be used as the training data of the learning engine.

In an embodiment, the electronic equipment 100 may transmit back to the server device 200 a difference between the learning engine generated after training the learning engine and the learning engine before training (for example, a difference in a parameter or a node structure such as a threshold value or a weighting value, or the like). Accordingly, the electronic equipment 100 may train the learning engine even without transmitting personal information to the server device 200, and the server device 200 may also use the difference of the learning engine received from the electronic equipment 100, thereby improving the learning engine held by the server device 200.

FIGS. 7 and 8 are diagrams illustrating an embodiment in which the electronic equipment 100 according to an embodiment of the present disclosure displays the recommendation of a do-not-disturb mode setting on a display 151.

Referring to FIG. 7, in an embodiment, if the recommendation of the do-not-disturb mode setting has been determined by the learning engine, the electronic equipment 100 may display, on the display 151, a pop-up menu recommending the do-not-disturb mode setting 710. The pop-up menu may display an interface (for example, a toggle type interface) in which the user may directly set the do-not-disturb mode.

Referring to FIG. 8, in another embodiment, if the recommendation of the do-not-disturb mode setting has determined by the learning engine, the electronic equipment 100 may display an interface including a shortcut 821 capable of setting the do-not-disturb mode. The interface may display a shortcut 820 related to a predetermined application or a shortcut 810 related to an application recommended according to the user's context together.

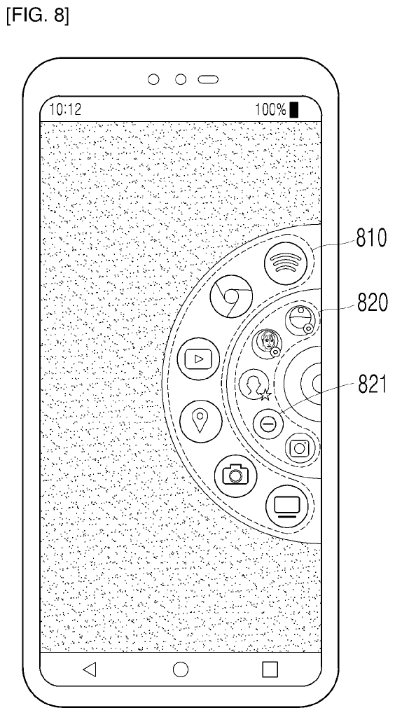

FIG. 9 is a diagram illustrating an embodiment in which the electronic equipment 100 according to an embodiment of the present disclosure displays, on a display 151, an interface for setting a release condition of the do-not-disturb mode. Referring to FIG. 9, the release of the do-not-disturb mode of the electronic equipment 100 will be described.

The electronic equipment 100 may display, on the display 151, a user interface for setting the do-not-disturb mode release condition (the do-not-disturb mode hold condition), in response to the user's input of the do-not-disturb mode setting for the interface recommending the do-not-disturb mode setting. The user interface may be an interface selectable by the user among predetermined conditions, or an interface in which the user may set a time at which the do-not-disturb mode is released.

In an embodiment, the interface for setting the do-not-disturb mode release condition (the do-not-disturb mode hold condition) may be to display a predetermined hold time (for example, ‘for one hour’), and may be the release condition based on the place.

For example, the place-based release condition may be a do-not-disturb mode release condition if the user leaves the place that has set the do-not-disturb mode, and in this case, the electronic equipment 100 may monitor the position information of the electronic equipment 100 through the sensor 140 or the communication module 110. If the intensity of the Wi-Fi signal of a specific AP received through the communication module 110 becomes weaken at a predetermined level or less or the connection of the specific AP is released, the electronic equipment 100 may determine as having left the place. Alternatively, if the intensity of the wireless communication signal received from a specific repeater becomes weaken at a predetermined level or less, it may be determined that the user has left the place. Alternatively, if the weakened intensity of the Wi-Fi signal of a specific AP or the weakened intensity of the wireless communication signal received from a specific repeater lasts for a certain time or more, it may be determined that the user has left the place. If the user has set the do-not-disturb mode release condition upon leaving the place, the electronic equipment 100 may release the set do-not-disturb mode when it is determined that the user has left the place.

In another embodiment, even if the user does not set the do-not-disturb mode release condition, the electronic equipment 100 may release the do-not-disturb mode based on the place.

For example, the learning engine recommends the setting of the do-not-disturb mode and the user sets the do-not-disturb mode based on the user context information extracted from the schedule information, and then the electronic equipment 100 may monitor the position information through the sensor 140 or the communication module 110 for the time corresponding to the time information in which the do-not-disturb mode has been set. Thereafter, if the monitored position information is changed, the electronic equipment 100 may release the do-not-disturb mode. In this case, if the position information monitored for the time corresponding to the time information in which the do-not-disturb mode has been set continuously changes, the electronic equipment 100 may determine that the user's schedule has been changed, and display an interface capable of releasing the do-not-disturb mode on the display 151.

Alternatively, if searching for the GPS coordinate information of the place included in the user context information extracted from the schedule information from the map DB, and determining that the monitored position information has been out of a certain range from the searched GPS coordinate information, the electronic equipment 100 may release the do-not-disturb mode.

In another embodiment, even when the user does not set the do-not-disturb mode release condition, the electronic equipment 100 may release the do-not-disturb mode based on the user context information including biometric information or motion information.

For example, the learning engine based on machine learning determines as a context that the user is on exercise and the do-not-disturb mode (automatically or through the user's input for the recommendation of the do-not-disturb mode) has been set, and then if it is determined that the exercise has been done as a result of applying the user context information including the biometric information or the motion information to the learning engine based on machine learning, the electronic equipment 100 may release the do-not-disturb mode.

For another example, the user has set the do-not-disturb mode in response to the recommendation of the do-not-disturb mode setting of the learning engine based on the user context information extracted from the schedule information, and then the electronic equipment 100 may monitor the biometric information or the motion information through the sensor 140 or the connected devices 340, 350 for the time corresponding to the time information in which the do-not-disturb mode has been set. Thereafter, if the monitored biometric information or motion information is determined as the movement operation of the user and the position information is changed, the electronic equipment 100 may release the do-not-disturb mode.

For another example, the learning engine has set the do-not-disturb mode based on the user context information during sleep, and then the electronic equipment 100 may release the do-not-disturb mode if it is determined that the user woken up based on the user context information including the monitored biometric information or motion information.

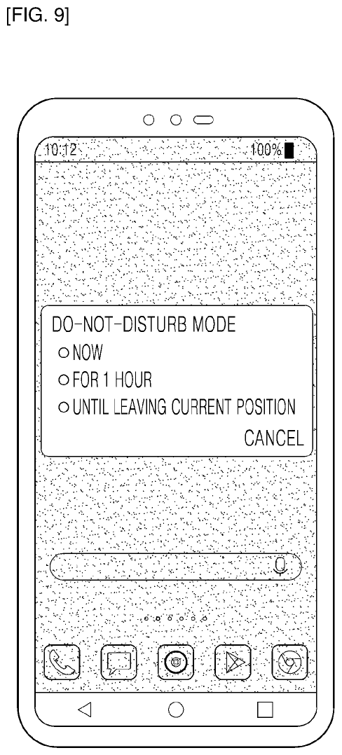

FIG. 10 is a flowchart explaining a control method of the electronic equipment 100 according to an embodiment of the present disclosure.

If the place where the user has been positioned and the time at which the user has been positioned at the corresponding place are suitable for a predetermined reference, the electronic equipment 100 may generate the place where the user has been positioned and the time at which the user has been positioned at the corresponding place as the learning information including the place information and the time information (S1010).

In another embodiment, the electronic equipment 100 may generate the learning information further based on at least one of the biometric information received from the vices 340, 350 connected with the electronic equipment 100, such as a wearable device, through wired or wireless communication or measured through the sensor or the motion information related to the user's movement.

The electronic equipment 100 may classify and analyze at least one learning information including the time information or the place information, generate pattern information based on common time information and place information of the learning information having repeatability (S1020), and set the generated pattern information as the determination reference of the learning engine (S1030).

The electronic equipment 100 may generate the time information or the place information based on physical information sensed by the sensor or external information received through communication and collect it as user context information (S1040). For example, the electronic equipment 100 may generate the time information based on the time synchronized with the base station 330 and the time at which the user has been position at a specific place, and generate the place information based on the GPS coordinates of the place where the user has been positioned, the network name (SSID) of an AP accessed by the electronic equipment 100, and the like.

The electronic equipment 100 may apply the collected user context information to the learning engine, and determine the recommendation of the do-not-disturb mode if the collected user context information has the commonality of a predetermined reference or more with the pattern information (S1050).

If the recommendation of the do-not-disturb mode setting is determined by the learning engine, the electronic equipment 100 may display an interface recommending the do-not-disturb mode setting on the display (S1060), and in an embodiment, the interface recommending the do-not-disturb mode setting may be a pop-up menu including an interface (for example, a toggle type interface) in which the user may directly set the do-not-disturb mode as in FIG. 7.

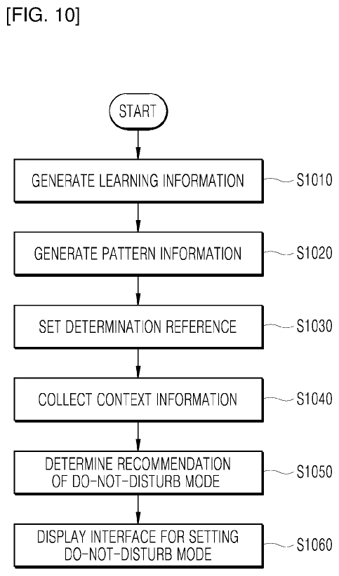

FIG. 11 is a flowchart explaining a control method of the electronic equipment 100 according to another embodiment of the present disclosure. In the following description, a description of parts overlapping with the description of FIG. 10 will be omitted.

The electronic equipment 100 may receive, from the server device 200, the learning engine based on machine learning trained so that the server device 200 recommends the setting of the do-not-disturb mode according to the context information by using the training data labeled with data having executed a do-not-disturb mode function under the conditions of various context information by a plurality of users or a specific user (S1110).

In another embodiment, the electronic equipment 100 may receive, from the server device 200, the learning engine based on machine learning trained so as to determine the user's context according to the context information by using the training data labeled with the user's context under the conditions of various context information.

In another embodiment, the electronic equipment 100 may retrain the learning engine based on the result of monitoring whether the user has set according to the recommendation of the do-not-disturb mode setting of the learning engine.

Thereafter, the electronic equipment 100 may collect user context information including time information and place information (S1120), determine the recommendation of the do-not-disturb mode by applying the collected user context information to the learning engine (S1130), and display an interface recommending the do-not-disturb mode setting on the display (S1140).

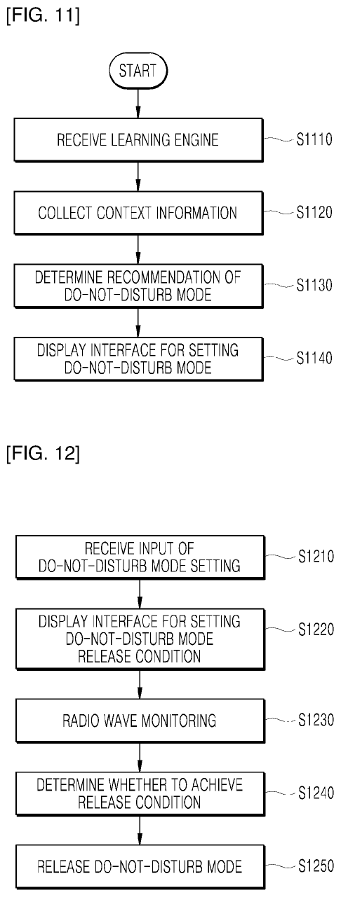

FIG. 12 is a flowchart explaining a control method for releasing a do-not-disturb mode of the electronic equipment 100 according to an embodiment of the present disclosure.

When receiving the input of the do-not-disturb mode setting (S1210), the electronic equipment 100 may display the user interface for setting the do-not-disturb mode release condition (the do-not-disturb mode hold condition) on the display (S1220).

In an embodiment, the do-not-disturb mode release condition may be received from the user among time-based or place-based release conditions.

If the user has selected the do-not-disturb mode release condition upon leaving the place, the electronic equipment 100 may monitor a change in the position information based on the received radio wave (Wi-Fi signal, wireless mobile communication signal, or the like) (S1230). In an embodiment, if the intensity of the Wi-Fi signal of a specific AP received through the communication module 110 becomes weaken at a predetermined level or less or the connection with the specific AP is released, the electronic equipment 100 may determine as having left the place (S1240) and release the do-not-disturb mode (S1250).

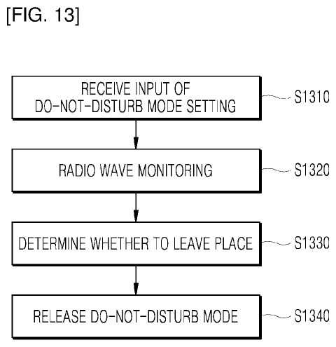

FIG. 13 is a flowchart explaining a control method for releasing a do-not-disturb mode of the electronic equipment 100 according to another embodiment of the present disclosure. In the following description, a description of parts overlapping with the description of FIG. 12 will be omitted.

When receiving the input of the do-not-disturb mode setting (S1310), the electronic equipment 100 may monitor the position information based on the radio wave received while the do-not-disturb mode has been set (S1320). Thereafter, if it is determined that the monitored position information has been out of a predetermined reference range (S1330), the electronic equipment 100 may release the do-not-disturb mode (S1340).

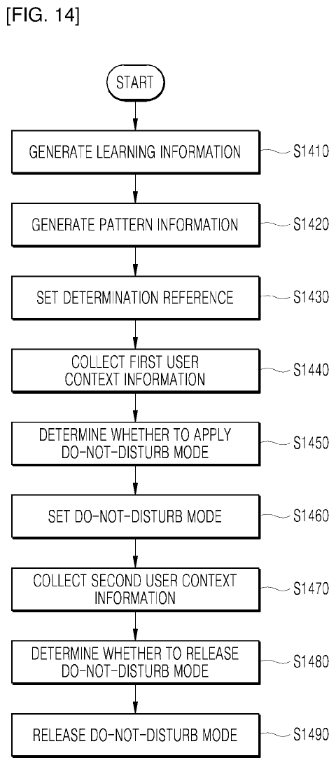

FIG. 14 is a flowchart explaining another control method of the electronic equipment 100 according to an embodiment of the present disclosure. In the following description, a description of parts overlapping with the description of FIGS. 10 to 13 will be omitted.

The electronic equipment 100 may generate the learning information including at least one of the biometric information received from the devices 340, 350 connected with the electronic equipment 100, such as a wearable device, through wired and wireless communication or measured through the sensor or the motion information related to the user's movement, the place information, and the time information (S1410), generate the pattern information by classifying and analyzing the learning information (S1420), and set the generated pattern information as the determination reference of the learning engine (S1430).

The electronic equipment 100 may set the do-not-disturb mode based on a result of determining (S1450) the setting of the do-not-disturb mode by applying the collected first user context information (S1440) to the learning engine (S1460).

The electronic equipment 100 may collect second user context information including the biometric information or the motion information after the do-not-disturb mode has been set (S1470), and release the do-not-disturb mode based on the result of determining (S1480) the release of the do-not-disturb mode by applying the collected second user context information to the learning engine (S1490).

The present disclosure described above may be implemented as a computer readable code on a medium in which a program has been recorded. The computer readable medium includes all types of recording devices in which data readable by a computer system readable may be stored. Examples of the computer readable medium include a Hard Disk Drive (HDD), a Solid State Disk (operation SSD), a Silicon Disk Drive (operation SDD), a ROM, a RAM, a CD-ROM, a magnetic tape, a floppy disk, an optical data storage device, etc. Moreover, the computer may include a processor 180 of a terminal.

The programs may be those specially designed and constructed for the purposes of the present disclosure or they may be of the kind well known and available to those skilled in the computer software arts. Examples of programs may include both machine codes, such as produced by a compiler, and higher-level codes that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

The order of individual steps in process claims according to the present disclosure does not imply that the steps must be performed in this order; rather, the steps may be performed in any suitable order, unless expressly indicated otherwise. The present disclosure is not necessarily limited to the order of operations given in the description. All examples described herein or the terms indicative thereof (“for example,” “such as”) used herein are merely to describe the present disclosure in greater detail. Accordingly it should be understood that the scope of the present disclosure is not limited to the example embodiments described above or by the use of such terms unless limited by the appended claims. Also, it should be apparent to those skilled in the art that various modifications, combinations, and alternations may be made depending on design conditions and factors within the scope of the appended claims or equivalents thereof.

It should be apparent to those skilled in the art that various substitutions, changes and modifications which are not exemplified herein but are still within the spirit and scope of the present disclosure may be made.

1. A method for controlling an electronic equipment, the method comprising:
collecting user context information comprising time information and place information from at least one of data stored in a sensor, a communication module, or a memory of the electronic equipment;
determining whether to recommend a do-not-disturb mode by applying the collected user context information to a learning engine; and
displaying, on a display of the electronic equipment, a user interface for setting the do-not-disturb mode in response to determining to recommend the do-not-disturb mode,
wherein the place information comprises a first identifier of a first network device with which the electronic equipment is connected wirelessly.

2. The method of claim 1, further comprising:
prior to the collecting the user context information,
determining whether the electronic equipment is positioned at a same place for a predetermined reference time;
generating learning information comprising the time information and the place information based on the determining whether the electronic equipment is positioned at the same place for the predetermined reference time;
determining repeatability of the learning information;
generating pattern information based on the determined repeatability of the learning information; and
setting the pattern information as a determination reference of the learning engine.

3. The method of claim 1, further comprising:
receiving biometric information of a user from an external device coupled with the electronic equipment to collect the user context information, wherein the biometric information comprises information related to at least one of electrocardiogram (ECG), heart rate (HR), or blood pressure (BP); and
recommending the do-not-disturb mode based on the biometric information.

4. The method of claim 1, further comprising:
collecting motion information related to a user's movement from an external device coupled with the electronic equipment or the sensor to collect the user context information; and
applying the user context information comprising the motion information to the learning engine to determine whether to recommend the do-not-disturb mode.

5. The method of claim 1, further comprising:
receiving an input for setting the do-not-disturb mode from a user via the displayed user interface;
displaying a second user interface for setting a do-not-disturb mode release condition associated with a place on the display in response to the input;
monitoring at least one of an intensity of a radio wave received from the first network device, the first identifier of the first network device, or a connection with the first network device;
determining whether the do-not-disturb mode release condition is satisfied when the electronic equipment is no longer located at the place based on the at least one of the intensity of the radio wave received from the first network device, the first identifier of the first network device, or the connection with the first network device; and
releasing the do-not-disturb mode when the do-not-disturb mode release condition is satisfied.

6. (canceled)

7. The method of claim 1, further comprising:
extracting the time information and the place information from message data or schedule data stored in the memory to collect the user context information.

8. The method of claim 7, further comprising:
prior to the collecting the user context information,
receiving, from a server device, the learning engine based on machine learning trained in advance so as to determine whether it is a context where the do-not-disturb mode is required based on the time information and the place information.

9. The method of claim 8, further comprising:
after the displaying the user interface on the display,
monitoring whether the do-not-disturb mode is set in response to a user input; and
retraining the learning engine based on a result of the monitoring.

10. The method of claim 9, further comprising:
after the retraining the learning engine,
transmitting information related to a difference between the received learning engine and the retrained learning engine to the server device.

11. The method of claim 7, further comprising:
receiving an input for setting the do-not-disturb mode via the displayed user interface from a user;
monitoring position information based on a radio wave received via the communication module, wherein the position information further comprises a second identifier of a second network device with which the electronic equipment is connected wirelessly;
determining deviation of the monitored position information from the extracted place information related to the message data or the schedule data stored in the memory based on the first identifier of the first network device and the second identifier of the second network device; and
releasing the do-not-disturb mode based on the deviation.

12. A method for controlling an electronic equipment, the method comprising:
extracting time information and place information from at least one of data stored in a sensor, a communication module, or a memory of the electronic equipment;
collecting first user context information by receiving biometric information of a user from an external device communicating with the electronic equipment, wherein the biometric information comprises information related to at least one of electrocardiogram (ECG), heart rate (HR), or blood pressure (BP);
determining whether to set a do-not-disturb mode by applying the collected first user context information to a learning engine; and
setting the do-not-disturb mode based on the determining
wherein the place information comprises an identifier of a network device with which the electronic equipment is connected wirelessly.

13. The method of claim 12, further comprising:
prior to the collecting the first user context information,
generating learning information comprising the time information, the place information, and the biometric information, when the electronic equipment is positioned at a same place for a predetermined reference time;
generating pattern information based on the learning information when the learning information is determined to have repeatability of at least a predetermined reference; and
setting the pattern information as a determination reference of the learning engine.

14. The method of claim 13, further comprising:
collecting motion information related to the user's movement from the external device or the sensor to collect the first user context information; and
applying the collected first user context information comprising the motion information to the learning engine to determine whether to set the do-not-disturb mode.

15. The method of claim 14, comprising:
after the setting the do-not-disturb mode,
receiving updated biometric information from the external device, wherein the updated biometric information comprises information related to at least one of electrocardiogram (ECG), heart rate (HR), or blood pressure (BP);
collecting second user context information by collecting the updated biometric information from the external device, the motion information from the external device or the sensor, and the place information comprising the identifier of the network device;
determining whether to release the set do-not-disturb mode by applying the collected second user context information comprising the updated biometric information, the motion information, and the place information comprising the identifier of the network device to the learning engine; and
releasing the do-not-disturb mode based on the second user context information applied to the learning engine.

16. A computer program product comprising a non-transitory computer readable medium having a computer readable program stored therein, wherein the computer readable program, when executed by a computing device, causes the computing device to:
collect user context information comprising time information and place information from at least one of data stored in a sensor, a communication module, or a memory of the computing device;
determine whether to recommend a do-not-disturb mode by applying the collected user context information to a learning engine; and
display, on a display of the computing device, a user interface for setting the do-not-disturb mode in response to determining to recommend the do-not-disturb mode
wherein the place information comprises an identifier of a network device with which the electronic equipment is connected wirelessly.

17. An electronic equipment, comprising:
a processor;
a memory electrically coupled with the processor and configured to store at least one instruction or a parameter of a learning model executable by the processor;
a sensor configured to sense physical information;
a communication module; and
a display configured to display a user interface,
wherein the processor is configured to:
collect user context information comprising time information and place information from at least one of data stored in the sensor, the communication module, or the memory;
determine whether to recommend a do-not-disturb mode by applying the collected user context information to a learning engine; and
cause the display to display the user interface for setting the do-not-disturb mode in response to determining to recommend the do-not-disturb mode
wherein the place information comprises an identifier of a network device with which the electronic equipment is connected wirelessly.

18. The electronic equipment of claim 17, wherein the processor is further configured to:
generate learning information comprising the time information and the place information when the electronic equipment is positioned at a same place for a predetermined reference time; and
set pattern information generated based on repeatability of the learning information as a determination reference of the learning engine.

19. The electronic equipment of claim 18, wherein the processor is further configured to:
collect the user context information by collecting biometric information of a user received via the communication module from an external device coupled with the electronic equipment; and
determine to recommend the do-not-disturb mode by applying the user context information comprising the biometric information to the learning engine.

20. The electronic equipment of claim 19, wherein the processor is further configured to:
collect the user context information by collecting motion information related to the user's movement received from the external device or the sensor; and
determine to recommend the do-not-disturb mode by applying the user context information comprising the motion information to the learning engine.

21. The electronic equipment of claim 18, wherein the processor is further configured to:
cause the display to display a second user interface for setting a do-not-disturb mode release condition associated with a place in response to a user input for setting the do-not-disturb mode;
monitor at least one of an intensity of a radio wave received from the network device, the identifier of the network device, or a connection with the network device via the communication module based on the do-not-disturb mode release condition set via the second user interface; and
determine whether the do-not-disturb mode release condition is satisfied when the electronic equipment is no longer located at the place based on the at least one of the intensity of the radio wave received from the network device, the identifier of the network device, or the connection with the network device.

22. (canceled)

23. The electronic equipment of claim 17, wherein the processor is further configured to:
collect the user context information by extracting the time information and the place information from message data or schedule data stored in the memory; and
receive, via the communication module, from a server device, the learning engine based on machine learning trained in advance so as to determine whether it is a context where the do-not-disturb mode is required based on the time information and the place information.

24. The electronic equipment of claim 23, wherein the processor is further configured to retrain the learning engine based on whether the do-not-disturb mode has been set in response to a user input.

25. (canceled)
